(19) United States
(12) Patent Application Publication
(10) Pub. No.: US 2005/0262575 A1
(43) Pub. Date: Nov. 24, 2005

(54) Systems and methods to secure restricted information

(76) Inventors: Jay S. Dweck, Armonk, NY (US); Mary D. Byron, Ridgewood, NJ (US); Bhavesh R. Patel, Somerset, NJ (US)

Correspondence Address: Buckley, Maschoff & Talwalkar LLC, Five Elm Street, New Canaan, CT, 06840, US

(21) Appl. No.: 10/952,333

(22) Filed: Sep. 28, 2004

Related U.S. Application Data
(60) Provisional application No. 60/551,587, filed on Mar. 9, 2004.

(51) Int. Cl. H04L 9/00; H04L 9/32; G06F 11/30; G06F 12/14

(52) U.S. Cl. 726/28; 713/193

(57) ABSTRACT

Systems and methods are provided to secure restricted information, such as restricted financial information. According to some embodiments, a user's request to execute an application on a secure application server is verified based on a user name, a user password, a unique identifier associated with a workstation, and a request authentication procedure. Moreover, according to some embodiments a file having restricted information cannot be attached to an email message. In still other embodiments, one display unit displays non-restricted information while another display unit displays restricted information.

### CROSS-REFERENCE TO RELATED APPLICATION

The present application claims the benefit of U.S. Provisional Patent Application No. 60/551,587 entitled “Systems and Methods to Secure Restricted Financial Information” and filed on Mar. 9, 2004.

### FIELD

The present invention relates to restricted information. In particular, the present invention relates to systems and methods to secure restricted information.

### BACKGROUND

In some cases, an enterprise may need to restrict access to information. For example, regulations or business procedures might require that a user (or a group of users) be prevented from accessing restricted financial information associated with a particular business deal or company. The restricted financial information might represent, for example, material non-public information and/or client confidential information.

FIG. 1 illustrates users and financial information 100. In this case, “advisory” users (e.g., users who advise clients and/or help facilitate business deals) might be allowed to access material non-public information, client confidential information, and public information. In contrast, non-advisory users (e.g., traders) and public users (e.g., users outside the enterprise) might only be allowed to access public information.

It is known that procedures can be established to erect a barrier, sometimes referred to as a “Chinese wall,” that prevents a user (or a group of users) from accessing restricted information. For example, an information manager might maintain a list of users who, for regulatory or other reasons should be allowed to access information associated with a particular merger transaction (e.g., a list that does not include traders who shouldn't know about the deal). Information associated with the deal (e.g., paper files and/or electronic files) might then be stored in a secure room—and the people on the list could be allowed to enter the room. According to another approach, a list might be kept of people who should be prevented from entering the room.

Such an approach, however, can be impractical. For example, in some cases a user should only have access to restricted information associated with a single deal or company (e.g., he or she might have access to client confidential information for company A but not for company B). In other cases, a user should be allowed to access all restricted information except for information associated with a particular deal or company (e.g., he or she might be allowed to access all deal information except the deal information associated with company B). Moreover, a single user might be associated with different types of restrictions for different deals and companies, and the restrictions could change over a period of time (e.g., a user might “cross the wall” for a limited period of time to handle a particular deal). As a result, managing and enforcing appropriate restrictions can be difficult—especially when there are a large number of users, deals, and/or companies.

In addition, it can be inefficient to enforce restrictions by limiting a user's physical access to information. For example, a user might need to travel to a specific location in order to access information associated with a particular deal. Such an approach can also be ineffective. For example, a user who is authorized to access material non-public information might inadvertently provide the information to someone who should not have access (e.g., by attaching a file to an email message or by printing a document on a public printer). That is, a user might not realize that certain information is restricted and/or that another user should not have access to the information.

### SUMMARY

To alleviate problems inherent in the prior art, the present invention introduces systems and methods to secure information.

In one embodiment of the present invention, it is determined that a user is attempting to attach information to an email message. It is then automatically determined whether or not the information includes restricted information. If the information includes restricted information, it is arranged for a link to the restricted information to be inserted without attaching the restricted information to the email message.

According to another embodiment, a user request is verified based on (i) user information, such a user name and password, (ii) a unique identifier (e.g., an address or directory) associated with a workstation, such as an Internet Protocol address, and (iii) a request authentication procedure. If the user request is verified, it is arranged for an application to be executed at a secure application server within a secure network and for information to be exchanged between the secure application server and the workstation through a firewall associated with the secure network, wherein the workstation is outside the secure network. It is also determined whether the user is allowed to access a file stored at a secure file server within the secure network based at least in part on access information associated with the file. If the user is allowed to access the file, it is arranged for information associated with the file to be provided to the application executing at the secure application server.

According to still another embodiment, it is arranged for non-restricted information to be displayed on a first display unit associated with a workstation. Similarly, it is arranged for restricted information to be displayed on a second display unit associated with the workstation.

According to yet another embodiment, a request is received from a user to send restricted financial information from a secure file server within a secure network to a printer outside the secure network. If the printer is authorized to output the restricted financial information, the restricted financial information is transmitted to the printer.

Another embodiment comprises: means for determining that a user is attempting to attach information to an email message; means for automatically determining if the information includes restricted information; and means for if the information includes restricted information, arranging to insert into the email message a link to the restricted information without attaching the restricted information to the email message.

Another embodiment comprises: means for verifying a user request based on (i) user information, (ii) a unique address associated with a workstation, and (iii) a request authentication procedure; means for, if the user request is verified, arranging for an application to be executed at a secure application server within a secure network and for information to be exchanged between the secure application server and the workstation through a firewall associated with the secure network, wherein the workstation is outside the secure network; means for determining whether the user is allowed to access a file stored at a secure file server within the secure network based at least in part on access information associated with the file; and means for, if the user is allowed to access the file, arranging for information associated with the file to be provided to the application executing at the secure application server.

Still another embodiment comprises: means for arranging for non-restricted information to be displayed on a first display unit associated with a workstation; and means for arranging for restricted information to be displayed on a second display unit associated with the workstation.

Yet embodiment comprises: means for receiving a request to send restricted financial information from a secure file server within a secure network to a printer outside the secure network; and means for, if the printer is authorized to output the restricted financial information, transmitting the restricted financial information to the printer.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 illustrates users and financial information according to some embodiments of the present invention.

FIG. 2 is a block diagram overview of a system according to some embodiments of the present invention.

FIG. 3 is a security apparatus according to some embodiments of the present invention.

FIG. 4 is a tabular representation of a user database according to one embodiment of the present invention.

FIG. 5 illustrates a file structure for a secure file server according to one embodiment of the present invention.

FIGS. 6 and 7 are a flow chart of a method to secure restricted information according to some embodiments of the present invention.

FIG. 8 is a flow chart of a display method according to some embodiments of the present invention.

FIG. 9 illustrates display units according to some embodiments of the present invention.

FIG. 10 is a flow chart of a method according to some embodiments of the present invention.

FIG. 11 illustrates displays according to some embodiments of the present invention.

FIG. 12 is a flow chart of a printing method according to some embodiments of the present invention.

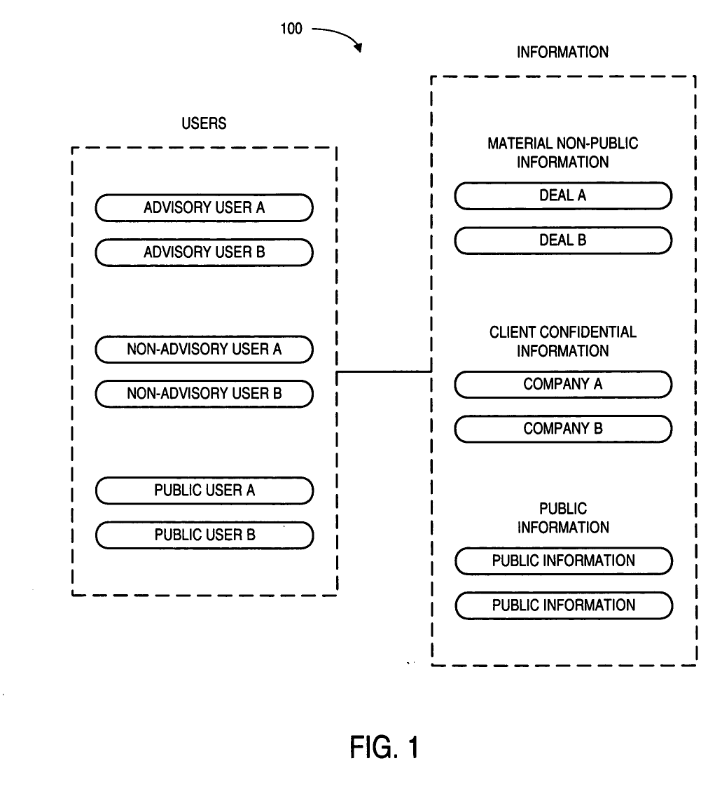

### DETAILED DESCRIPTION

Some embodiments described herein are associated with “restricted information.” As used herein, the phrase “restricted information” may refer to any information that should be accessed by certain users but not by other users. The restricted information might include, for example, electronic files, text information, spreadsheets, graphical information, and/or audio information. Examples of restricted information include (but are not limited to) financial information, material non-public information, confidential, client confidential or proprietary or classified information, information subject to legal, executive, or professional privilege or immunity, information for which a particular security clearance may be required, and information restricted by a regulatory body or self-regulatory organization or by government, judicial, administrative, regulatory, self regulatory organization rule, order or authority. Other examples include internal information, trade secret information, technical information, and “firm” confidential information.

According to some embodiments, the restricted information may be associated with a privacy statute (e.g., in order to comply with European Union privacy requirements). As still another example, the restricted information might be associated with a governmental investigation (e.g., in connection with a grand jury investigation or an investigation of suspicious activities).

System Overview

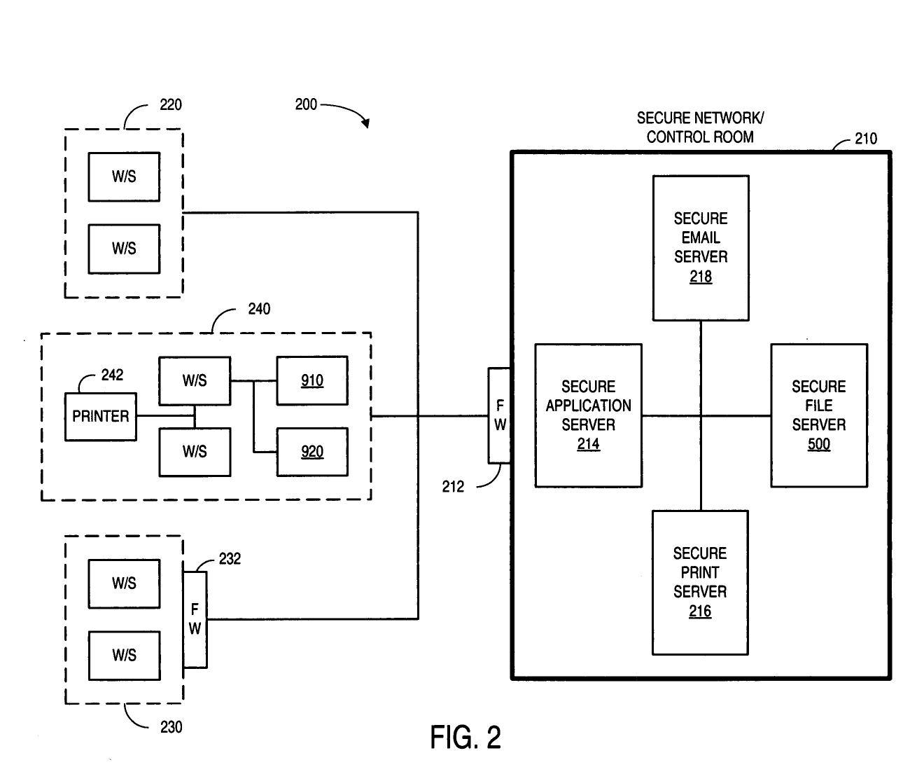

FIG. 2 is a block diagram overview of a system 200 according to some embodiments of the present invention. The system 200 includes a control room (e.g., a physically secure room) having a secure “network” 210. As used herein, the term “network” may refer to, for example, a Local Area Network (LAN), a Metropolitan Area Network (MAN), a Wide Area Network (WAN), a proprietary network, a wireless network, or an Internet Protocol (IP) network such as the Internet, an intranet or an extranet.

The secure network 210 may communicate with other networks 220, 230, 240 via an interface having a “firewall” 212. As used herein the term “firewall” may refer to any hardware and/or software that protects the resources of a network. For example, the firewall 212 might examine network packets to determine whether the packets will be forwarded to destinations within the secure network 210. The firewall 212 might also include a proxy server that makes network requests on behalf of workstation users within the secure network 210.

The secure network 210 may include a secure application server 214. The secure application server 214 may be any device on which applications (e.g., Microsoft® WORD) can be executed for other workstations. The secure application server 214 might be, for example, a CITRIX® server that provides secure, on-demand access to applications.

The secure network 210 may also include a secure print server 216 to facilitate the transfer of information to a printer. In addition, the secure network 210 may include a secure email server 218 to facilitate the transfer of information via email messages. The secure email server 218 might be, for example, a Microsoft® EXCHANGE server or a BLACKBERRY® server.

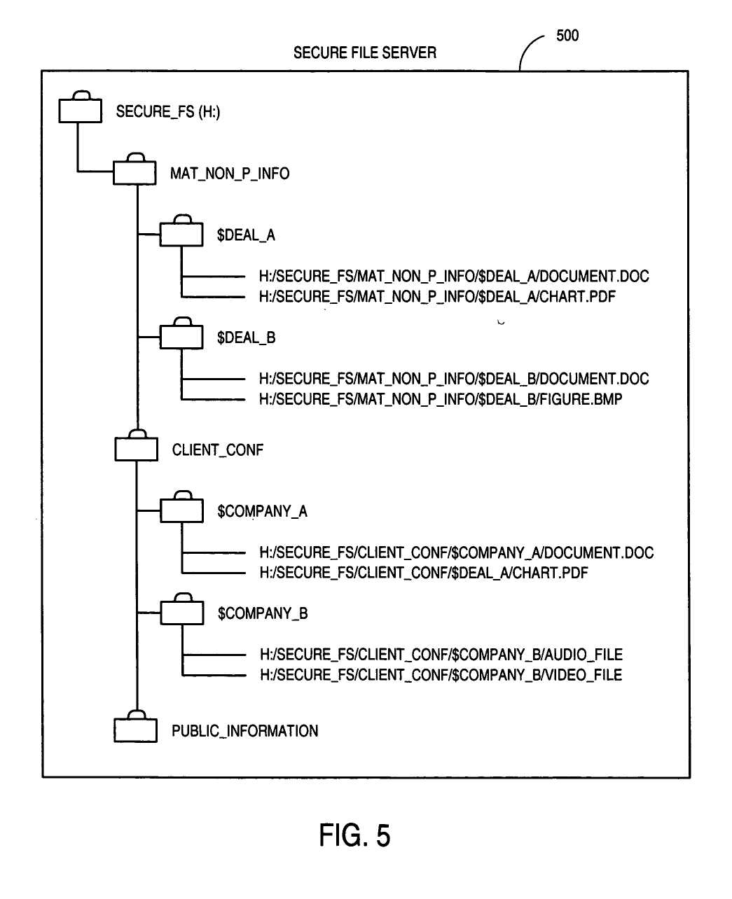

The secure network 210 may further include a secure file server 500 that stores information (e.g., as described with respect to FIG. 5). Although a single secure file server 500 is illustrated in FIG. 2, embodiments may include any number of secure file servers (as well as any other component illustrated in FIG. 2). Moreover, a single device might act as multiple components (e.g., a single computer might act as both the secure print server 216 and the secure email server 218).

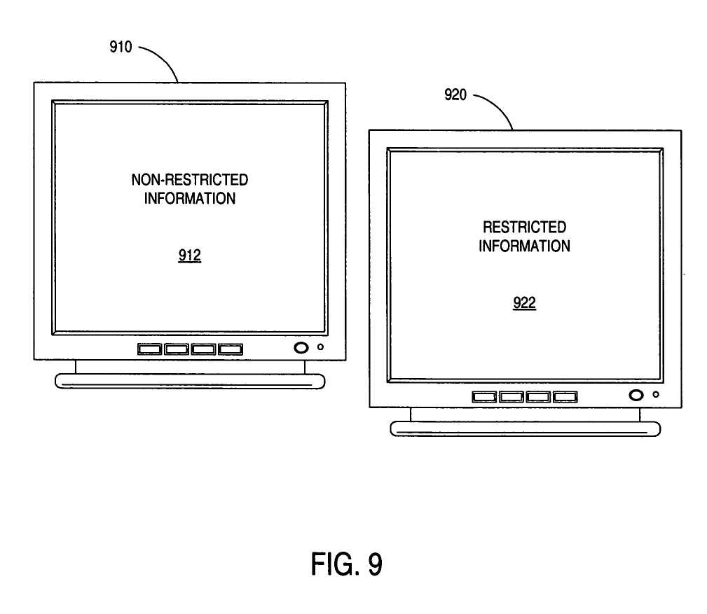

An external network 220 (e.g., external to the control room) may include a number of workstations that exchange information with the secure network 210 via the firewall 212. In some cases, an external network 230 may also have its own firewall 232. Note that in addition to workstations, an external network 240 could include a printer 242 and/or display units 910, 920 (described with respect to FIG. 9).

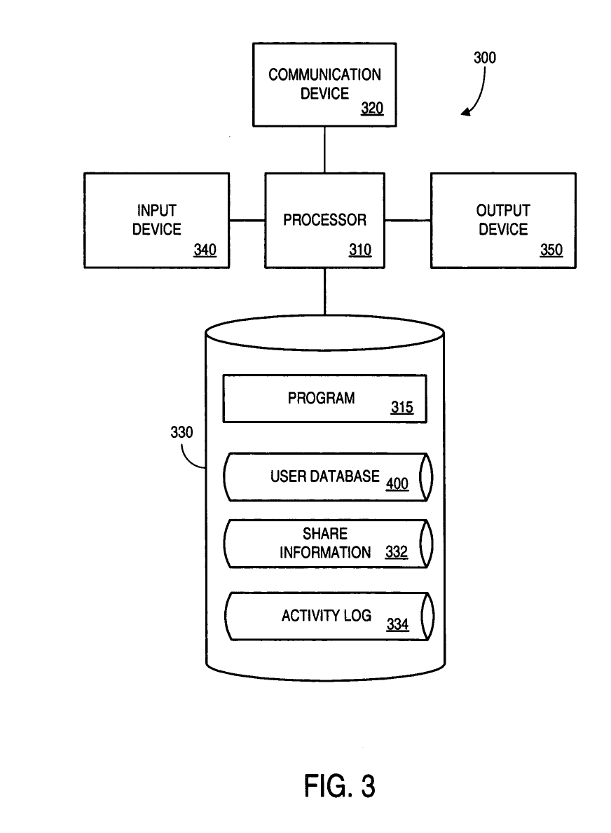

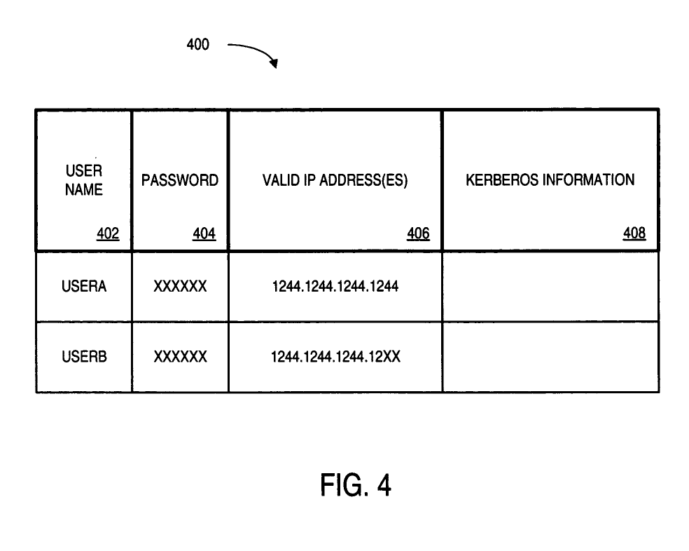

The security features of the system 200 according to some embodiments will now be described with respect to FIGS. 3 and 4.

Security Apparatus

FIG. 3 is a security apparatus 300 according to some embodiments of the present invention. The security apparatus 300 may be associated with, for example, any one or more of the components of the secure network 210 described with respect to FIG. 2. The security apparatus 300 includes a processor 310, such as one or more INTEL® Pentium® processors, coupled to a communication device 320 configured to communicate via, for example, a communication channel or network. The communication device 320 may be used to communicate, for example, with one or more workstations or servers. The processor 310 may also receive information via an input device 340 (e.g., a keyboard or computer mouse used to define security information) and provide information via an output device 350 (e.g., a display or printer that provides security information).

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

As shown in FIG. 3, the storage device 330 also stores: a user database 400; a share information database 332; and an activity log 334 (e.g., to store a history of security related information). An example of a database that may be used in connection with the security apparatus 300 will now be described in detail with respect to FIG. 4. The illustration and accompanying description of the database presented herein is exemplary, and any number of other database arrangements could be employed besides those suggested by the figures.

Referring to FIG. 4, a table represents the user database 400 that may be stored at the security apparatus 300 according to an embodiment of the present invention. The table includes entries identifying users that may access restricted information. The table also defines fields 402, 404, 406, 408 for each of the entries. The fields specify: a user name 402, a password 404, one or more valid IP addresses 406, and Kerberos information 408. The information in the user database 400 may be created and updated, for example, based on information received from a security administrator. According to some embodiments, biometric information (e.g., a fingerprint or retinal scan) may be used to provide security.

The user name 402 may be an alphanumeric code associated with a particular user. The password 404 may be another alphanumeric code associated with that user. The user name 402 and password 404 might be defined, for example, by the user or by a security administrator.

Referring again to FIG. 3, the storage device 330 stores a program 315 for controlling the processor 310. The processor 310 performs instructions of the program 315, and thereby operates in accordance with the present invention.

According to some embodiments, a user accesses a workstation and requests to execute an application on the secure application server 214. The request is then verified based on (i) the user name, (ii) the user password, (iii) the IP address associated with the workstation, and (iv) a request authentication procedure (e.g., Kerberos). Although an IP address is provided herein as an example, other unique identifiers (e.g., unique to the system) such as a Media Access Control (MAC) address could also be used. Note that different components might perform different parts off the verification. For example, the workstation might verify the user name and password. The security apparatus 300 might then verify that the request was received from an IP address associated with that user (or workstation). In addition, the security apparatus 300 might authenticate the request using tickets and an authentication server in accordance with the user's Kerberos information.

If the user request is verified, it is arranged for an application to be executed at the secure application server 214 within the secure network 210 and for information to be exchanged between the secure application server 214 and the workstation through the firewall 212. For example, when a request from a user external to the control room is received, a copy of Microsoft EXCEL® might be executed on a CITRIX server located inside the control room.

It can then be determined whether the user is allowed to access a file stored at the secure file server 500 within the secure network 210 based at least in part on access information associated with the file (e.g., as stored in the share information database 332). According to some embodiments, the access information comprises Distributed File System (DFS) information. For example, FIG. 5 illustrates a hierarchical file structure for a secure file server 500. As can be seen, the file structure might include material non-public information for a number of different deals (located in a “MAT_NON_P_INFO” folder), client confidential information for a number of different clients (located in a “CLIENT_CONF” folder), and public information. Moreover, each of the files and/or folders might be accessible by different sets of users (e.g., depending on the role each user is performing with respect to a transaction).

If the user is allowed to access the file (e.g., in accordance with the access information), it can be arranged for information associated with the file to be provided to the application executing at the secure application server 214 (e.g., a Microsoft EXCEL® spreadsheet might be opened). The user can then access and/or change the information as appropriate. For example, an analyst might be allowed to open a file stored in the “$DEAL_B” folder (while a trader might not even be able to see that folder).

According to some embodiments, the names of files or folders that contain restricted information are identifiable. In the example illustrated in FIG. 5, files or folders that contain restricted information begin with the “$” character. Of course, other approaches could be used to identify restricted information (e.g., by using another naming convention or maintaining a separate database).

Secure Email

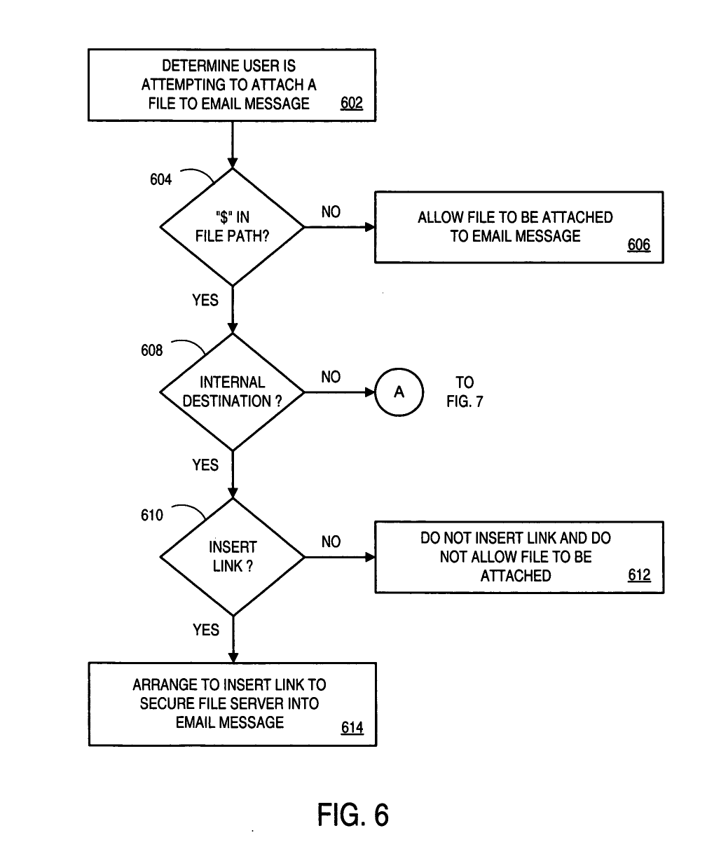

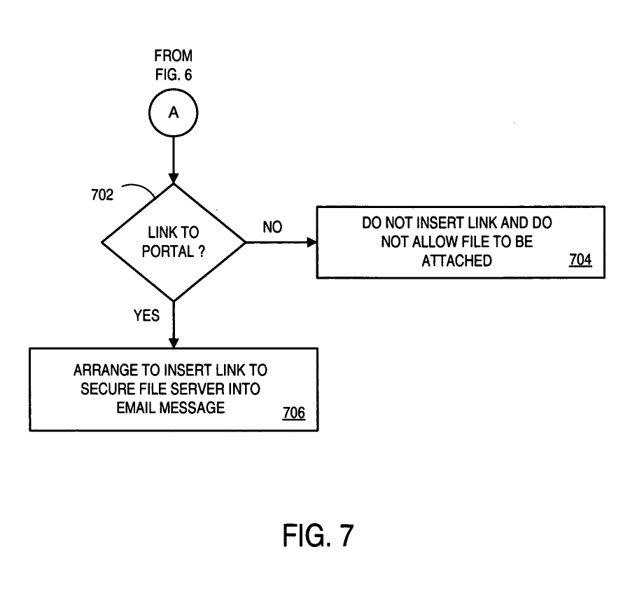

FIGS. 6 and 7 are a flow chart of a method to secure restricted information according to some embodiments of the present invention. The flow charts described herein do not imply a fixed order to the steps, and embodiments of the present invention may be practiced in any order that is practicable.

At 602, it is determined that a user is attempting to attach information to an email message. Note that the method of FIGS. 6 and 7 might be performed, for example, by an email application plug-in, an email application object, and/or an email application script. For example, an email application plug-in might detect that the user has selected a file stored on the secure file server to be attached to an email message. Note that, as used herein, a file that is “inserted” into the body of an email message is considered “attached” to that email message.

At 604, it is automatically determined whether or not the information includes restricted information (e.g., material non-public information or client confidential information). The determination may be based on, for example, a file name, a file path, directory share information, and/or DFS information. In this example, all files and folders that contain restricted information begin with the “$” character. Thus, if no appears in the file path, the information is not restricted and is allowed to be attached to the email message at 606.

If at least one “$” appears in the file path, it is determined at 608 if the destination of the email message is internal to an enterprise. For example, any destination (e.g., “to:” or “cc:”) other than “______@enterprise.com” might be assumed to be external to the enterprise. FIG. 7 describes the steps that may be taken when it is not determined that the destination is internal.

At 610, it is determined whether a link to the restricted information should be inserted into (e.g., attached to) the email message. For example, the user might be notified that he or she has attempted to attach a restricted file to the email message. The user might then be asked if a Uniform Resource Locator (URL) link to the file should be attached to the email message. An indication may then be received from the user, such as when he or she activates an “OK” Graphical User Interface (GUI) icon.

If no link is to be inserted, the process ends without attaching the file to the email message at 612. Otherwise, the link to the file's location on the secure file server 500 is inserted at 614 (without attaching the file). In this way, the person who receives the email can attempt to retrieve the restricted information from the secure file server 500, and will only be able to do so if he or she should have access to that information. Thus, the inadvertent disclosure of restricted information may be avoided.

FIG. 7 illustrates steps that may be taken when a user attempts to attach restricted information to an email message that has an external destination. At 702, it is determined whether a link to a web portal should be inserted into the email message. For example, the user might be notified that he or she has attempted to attach a restricted file and that the destination of the message is external to the enterprise. The user might then be asked if a URL link to a web portal associated with the enterprise should be attached to (or inserted within) the email message. If no link is to be inserted, the process ends without attaching the file to the email message at 704.

If a link is to be inserted, the link to the web portal is inserted at 706 (without attaching the file). In this way, the person who receives the email can access the web portal via a secure web interface, such as an interface that provides the restricted information to the party via the Secure Sockets Layer (SSL) protocol (assuming he or she has been granted access to the restricted information). Moreover, according to some embodiments the restricted information is removed (e.g., “wiped”) from the web portal after the information is provided to the party.

Dual Displays

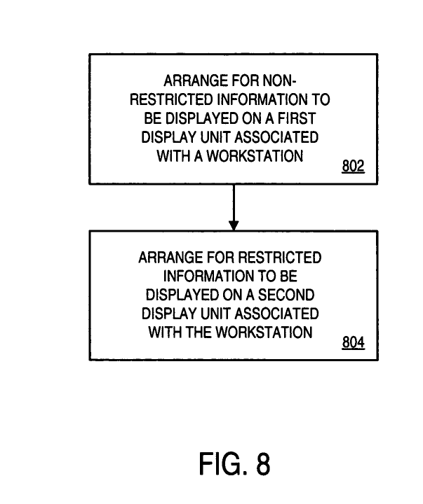

Referring again to FIG. 3, according to some embodiments a single workstation is coupled to two different display units 910, 920. FIG. 8 is a flow chart of a display method according to this embodiment. At 802, it is arranged for non-restricted information (e.g., public information) to be displayed on a first display unit associated with a workstation. Similarly, at 804 it is arranged for restricted information (e.g., client confidential information) to be displayed on a second display unit associated with that workstation.

For example, FIG. 9 illustrates two display units 910, 920 according to some embodiments of the present invention. The first display unit 910 provides non-restricted information 912 and the second display unit 920 provides restricted information 922. In this way, a user may more easily determine whether or not a file contains restricted information. According to some embodiments, a GUI prevents the user from moving an item from the second display unit 920 to the first display unit 910. Moreover, different color schemes might be associated with the first and second display units 910, 920 to help the user remember that the second display unit 920 is providing confidential information (e.g., the restricted information 922 might be provided on an orange colored desktop).

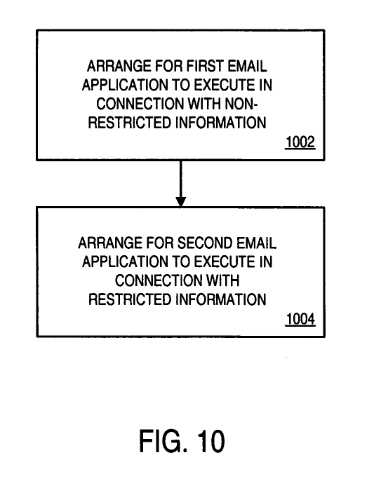

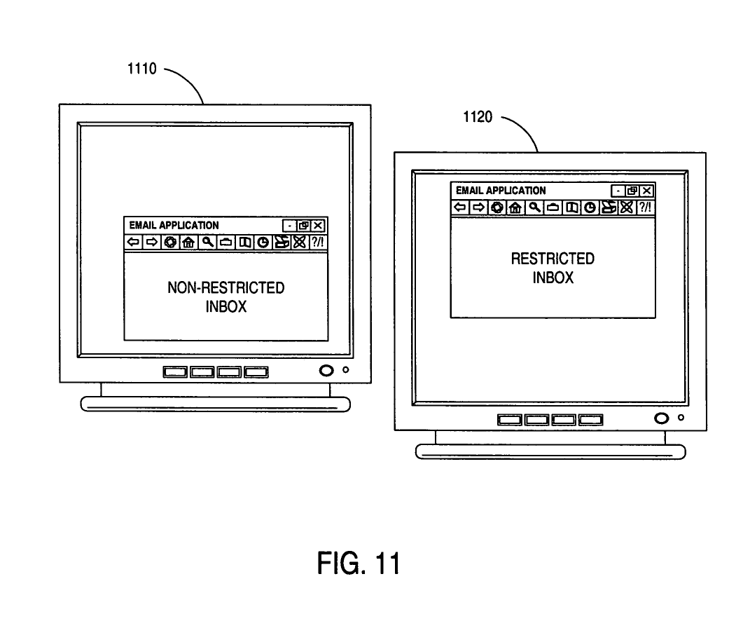

FIG. 10 is a flow chart of a method according to some embodiments of the present invention. In this case, at 1002 it is arranged for a first email application to execute in connection with non-restricted information. Similarly, at 1004 it is arranged for a second email application to execute in connection with restricted information (e.g., the second email application might execute on the secure email server 218). For example, FIG. 11 illustrates two displays 1110, 1120 according to this embodiment. In this case, a first email application executes and is displayed on the first display unit 1110 (e.g., with a non-restricted inbox) and a second email application executes and is displayed on the second display unit 1120 (e.g., with a restricted inbox). Moreover, a document with restricted information might only appear on the second display unit 1120. This is another way to help the user remember that the information exchanged via the restricted inbox may contain restricted information (e.g., to reduce the likelihood of mistakenly disclosing restricted information to an unauthorized party).

Secure Printing

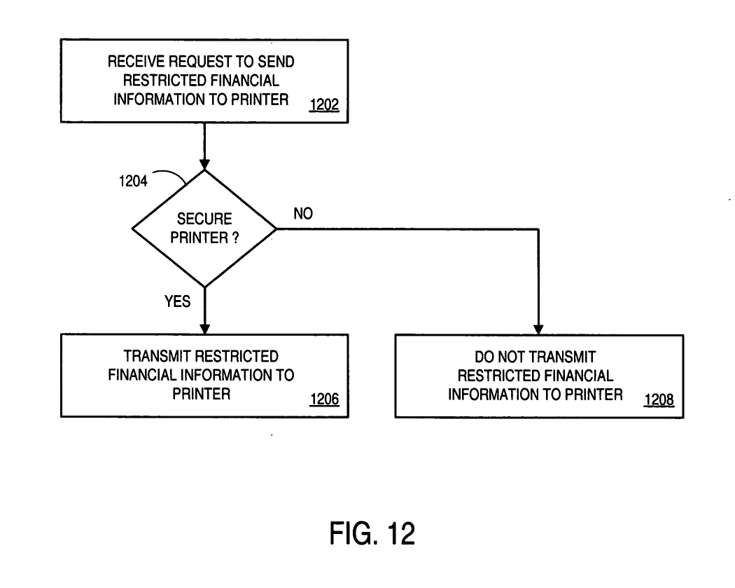

FIG. 12 is a flow chart of a printing method according to some embodiments of the present invention. At 1202, a request is received to send restricted financial information from a secure file server within a secure network to a printer outside the secure network. For example, a user may attempt to print a document that includes the “$” character in the document's file path. If the printer is authorized to output the restricted financial information at 1204, the restricted financial information is transmitted to the printer at 1206. If the printer is not authorized to output the restricted financial information at 1204, the restricted financial information is not transmitted to the printer at 1208 (e.g., the user might be asked to select another printer that is in a secure location).

Thus, embodiments of the present invention may provide efficient access to secure information while reducing the likelihood that such information will be inadvertently provided to parties who should not be able to access the information.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although some embodiments have been described herein with respect to financial information, the present invention may be used in connection with any other type of restricted information. For example, a governmental regulation might require that access to certain documents be limited (e.g., documents might be considered “classified” or “secret”). Similarly, a judicial decree or court order might limit who should be allowed to access information (e.g., only the parties to a civil action and a limited number of attorneys might be allowed to view trade secret information). As another example, access to information that concerns a person's expectation of privacy might be limited (e.g., a person's medical records). As still another example, a limited number of bank employees may be allowed to access information when suspicious activity has been detected with respect to a bank account (e.g., transferring large amounts of money out of a foreign country). Note that in some cases, an enterprise might be required to take “reasonable” steps to protect information or a statute might explicitly provide a “safe harbor” when certain protections are in place. In either case, some or all of the various embodiments described herein might be used to demonstrate that such obligations have been met.

Moreover, the systems provided herein are merely for illustration and embodiments may be associated with any type of network topologies. In addition, although two display units are described with respect to FIG. 9, additional display units might be provided (e.g., a first display unit might provide public information, a second display unit might provide material non-public information, and a third display unit might provide client confidential information).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. An apparatus to secure information, comprising:
a processor; and
a storage device in communication with said processor and storing instructions adapted to be executed by said processor to:
verifying a user request based on (i) user information, (ii) a unique address associated with a workstation, and (iii) a request authentication procedure,
if the user request is verified, arrange for an application to be executed at a secure application server within a secure network and for information to be exchanged between the secure application server and the workstation through a firewall associated with the secure network, wherein the workstation is outside the secure network,
determine whether the user is allowed to access a file stored at a secure file server within the secure network based at least in part on access information associated with the file, and
if the user is allowed to access the file, arrange for information associated with the file to be provided to the application executing at the secure application server.

2. The apparatus of claim 1, wherein the storage device further stores at least one of: (i) a user database, (ii) share information, or (iii) an activity log.

3. The apparatus of claim 1, wherein the user information includes a user name and a user password.

4. The apparatus of claim 1, wherein the unique identifier associated with the workstation comprises one of: (i) an Internet Protocol address, or (ii) a media access control address.

5. The apparatus of claim 1, wherein the access information is further associated with a folder containing with the file.

6. A method to secure information, comprising:
determining that a user is attempting to attach information to an email message;
automatically determining if the information includes restricted information; and
if the information includes restricted information, arranging to insert into the email message a link to the restricted information without attaching the restricted information to the email message.

7. The method of claim 6, wherein the restricted information comprises at least one of: (i) financial information, (ii) material non-public information, (iii) client confidential information, (iv) confidential information, (v) internal information, (vi) trade secret information, (vii) technical information, or (viii) firm confidential information.

8. The method of claim 6, wherein the method is associated with at least one of: (i) an email application plug-in, (ii) an email application object, or (iii) an email application script.

9. The method of claim 6, wherein the determination that the user is attempting to attach information to an email message is based on at least one of: (i) a file name, (ii) a file path, (iii) directory share information, and (iv) distributed file system information.

10. The method of claim 6, wherein the restricted information is stored at a secure file server on a secure network.

11. The method of claim 6, wherein said arranging includes:
receiving from the user an indication as to whether or not the link should be inserted into the email message.

12. The method of claim 6, further comprising:
determining if the destination of the email message is internal to an enterprise,
wherein the link to the restricted information is only inserted into the email message if the destination is internal to the enterprise.

13. The method of claim 12, further comprising:
if the destination of the email message is not internal to the enterprise,
arranging to insert into the email message a link to a web portal.

14. The method of claim 13, further comprising:
arranging for the web portal to provide the restricted information to a party that is not internal to the enterprise via a secure web interface.

15. The method of claim 14, wherein the restricted information is provided to the party via the secure sockets layer protocol and the method further comprises:
removing the restricted information from the web portal after the information is provided to the party.

16. A medium storing instructions adapted to be executed by a processor to perform a method to secure information, said method comprising:
determining that a user is attempting to attach information to an email message,
automatically determining if the information includes restricted information, and
if the information includes restricted information, arranging to insert into the email message a link to the restricted information without attaching the restricted information to the email message.

17. A method to secure information, comprising:
verifying a user request based on (i) user information, (ii) a unique identifier associated with a workstation, and (iii) a request authentication procedure;
if the user request is verified, arranging for an application to be executed at a secure application server within a secure network and for information to be exchanged between the secure application server and the workstation through a firewall associated with the secure network, wherein the workstation is outside the secure network;
determining whether the user is allowed to access a file stored at a secure file server within the secure network based at least in part on access information associated with the file; and
if the user is allowed to access the file, arranging for information associated with the file to be provided to the application executing at the secure application server.

18. The method of claim 17, wherein the user information includes at least one of: (i) a user name, (ii) a user password, or (iii) biometric information.

19. The method of claim 17, wherein the unique identifier associated with the workstation comprises one of: (i) an Internet Protocol address, or (ii) a media access control address.

20. The method of claim 17, wherein the file is associated with at least one of: (i) restricted financial information, (ii) material non-public information, (iii) client confidential information, (iv) confidential information, (v) internal information, (vi) trade secret information, (vii) restricted technical information, or (viii) firm confidential information.

21. The method of claim 20, wherein the access information is based on at least one of: (i) the user's role, (ii) deal information, or (iii) company information.

22. The method of claim 17, wherein the access information is further associated with a folder containing with the file.

23. A method to secure information, comprising:
arranging for non-restricted information to be displayed on a first display unit associated with a workstation; and
arranging for restricted information to be displayed on a second display unit associated with the workstation.

24. The method of claim 23, wherein the restricted information comprises at least one of: (i) financial information, (ii) material non-public information, (iii) client confidential information, (iv) confidential information, (v) internal information, (vi) trade secret information, (vii) technical information, or (viii) firm confidential information.

25. The method of claim 23, where a graphical user interface is prevented from moving an item from the second display unit to the first display unit.

26. The method of claim 23, wherein different color schemes are associated with the first and second display units.

27. An apparatus, comprising:
a workstation;
a first display unit associated with the workstation; and
a second display unit associated with the workstation,
wherein the first display unit is to display non-restricted information and the second display unit is to display restricted information.

28. A method to secure information, comprising:
receiving a request to send restricted financial information from a secure file server within a secure network to a printer outside the secure network; and
if the printer is authorized to output the restricted financial information, transmitting the restricted financial information to the printer.
